(19) United States
(12) Patent Application Publication
(10) Pub. No.: US 2009/0251882 A1
(43) Pub. Date: Oct. 8, 2009

(54) LIGHT-EMITTING DIODE ILLUMINATION STRUCTURES

(75) Inventor: William R. Ratcliffe, Thousand Oaks, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: GENERAL LED, INC., San Luis Obispo, CA (US)

(21) Appl. No.: 12/062,490

(22) Filed: Apr. 3, 2008

(51) Int. Cl. F21V 9/16; F21V 9/00

(52) U.S. Cl. 362/84; 362/235; 362/231

(57) ABSTRACT

Illumination device embodiments are provided which include a transparent bulb that carries at least one phosphor. A redirector is positioned within the bulb and at least one light-emitting diode (LED) is positioned over the redirector to be energized and emit light that excites the phosphor. The redirector helps to diffuse the resultant mix of LED-emitted light and phosphor-emitted light that issues from the device. The redirector also provides a heat path away from the LEDs. In a device embodiment, LEDS form first and second diode groups that have emission peaks in different regions. Selectively energizing these groups alters the color temperature of the device's light. Energizing both groups and varying currents of each group also alters the color temperature of the device's light. In other device embodiments, the redirector has a portion outside the bulb which may also define protuberances that enhance heat radiation. In yet other device embodiments, each LED may have an associated phosphor. Some embodiments may be further enhanced by the further addition of a phosphor to the bulb.

### BACKGROUND OF THE INVENTION

1. Field of the Invention

The present invention relates generally to illumination devices.

2. Description of the Related Art

Conventional illumination devices include incandescent lamps which are filled with an inert gas to reduce evaporation of a glass-enclosed filament. Electrical current flows through various arrangements of electrical contacts (e.g., an Edison screw and a bayonet base) to heat the filament to an extremely high temperature (e.g., 2000 to 3300 Kelvin). In a halogen version, the glass envelope is filled with a halogen gas. Halogen lamps can thus operate at a higher filament temperature to thereby provide a higher luminous efficiency.

In contrast, current flow through a fluorescent lamp excites mercury vapor in argon or neon gas which generates a plasma that produces short-wave ultraviolet light. This light causes a phosphor coating on the lamp's inner surface to fluoresce and produce visible light. A ballast is included to regulate the flow of power through the lamp. Fluorescent lamps are often housed in a long, slender glass tube (generally positioned between straight bipin bases) but in compact fluorescent lamps (CFLs), the tube is formed in a spiral arrangement which is carried on an Edison screw so that the lamp can replace an incandescent light bulb.

Although the purchase price of incandescent lamps is low and their color rendering index is quite high, their luminous efficacy is poor and their life span is limited to something on the order of 1,000 hours. The life span of fluorescent lamps is significantly higher (e.g., on the order of 10,000 hours) and their luminous efficacy is better but their color rendering index does not match that of incandescent lamps.

### BRIEF SUMMARY OF THE INVENTION

The present invention is generally directed to light-emitting diode illumination devices. The drawings and the following description provide an enabling disclosure and the appended claims particularly point out and distinctly claim disclosed subject matter and equivalents thereof.

### BRIEF DESCRIPTION OF THE DRAWINGS

FIGS. 1A, 1B and 1C are front, top and side views of a light-emitting diode illumination device embodiment;

FIGS. 2A-2F are views of different arrangements of light-emitting diodes, conductors and substrates that can be used in the illumination device of FIGS. 1A-1C;

FIGS. 3A, 3B and 3C are front, top and side views of another light-emitting diode illumination device embodiment;

FIG. 4 is a diagram that illustrates adjustment of color temperature in the embodiments of FIGS. 3A-3C;

FIG. 5 is a side view of another illumination device embodiment;

FIG. 6 is a view along the plane 6-6 of FIG. 5;

FIG. 7 is a side view of another illumination device embodiment; and

FIG. 8 illustrates exemplary conventional lamps which can be replaced with illumination device embodiments described herein with reference to FIGS. 1-4.

### DETAILED DESCRIPTION OF THE INVENTION

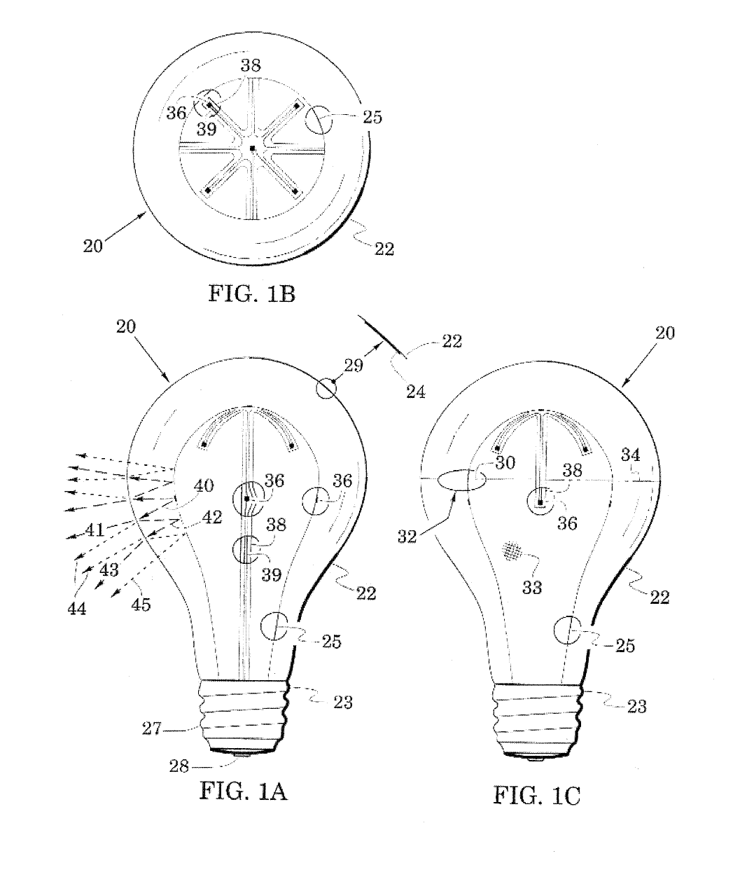

FIGS. 1A-8 illustrate illumination device embodiments which are structured with light sources whose life span and luminous efficacy are substantially greater than prior art illumination devices. In addition, the color rendering index of these embodiments is competitive with that of the prior art.

In particular, the illumination device embodiment 20 of FIGS. 1A-1C includes a bulb 22, a base 23, a redirector 25 and an excited light source such at least one phosphor 24. The bulb 22 is preferably formed from a substantially transparent or translucent material such as glass or a polymer and is preferably supported by the base 23 (e.g., joined to the base). Although the bulb 22 is shown to have a bulbous form in these figures, it may generally take on various other forms such as those shown in the lamps 112, 113 and 114 of FIG. 5.

The base 23 can take a variety of forms that are suitable for installation into various conventional lighting fixtures. In one embodiment, therefore, the base is configured as an Edison screw. Edison screws form a system of light bulb connectors in which a designation Exx refers to the base diameter in millimeters. For example an E26 Edison screw has a base diameter of 26 millimeters and is widely available for installation into conventional household lamps in the United States. Electrical contact is made through a threaded outer surface 27 and an inner contact 28. Other base embodiments may be formed in accordance with other typical lighting bases (e.g., bayonet mounts and straight bipin bases).

A primary light source is provided to generate primary emitted light which excites the generation of secondary emitted light from a secondary light source. In a device embodiment, the secondary light source is the phosphor 24 and the primary light source is formed with a plurality of spaced light-emitting diodes (LEDs) 36. Although wavelengths of the primary emitted light and wavelengths of the secondary emitted light of the excitation source 24 can be anywhere in the electromagnetic spectrum, they are in the visible spectrum (e.g., between 400 and 700 nanometers) in at least some illumination device embodiments.

The phosphor 24 is formed of various phosphorescent or luminescent materials that emit light at emission wavelengths (e.g., wavelengths above 500 nanometers (nm)) when excited by light at excitation wavelengths (e.g., wavelengths below 480 nm). Typical phosphors are combinations of various elements (e.g., cerium, yttrium, aluminum, and garnet) that are generally powdered and bound or suspended in various carriers (e.g., adhesives and solvents). They can be deposited as films or mixed into other materials such as resins and polymers. Exemplary phosphors are provided by various manufacturers such as Intermatix in Fremont, Calif. (e.g., see phosphor data sheets in Intermatix's 2008 Product Catalog) and Molecular Technology headquartered in Berlin, Germany.

In FIG. 1A, a portion of the bulb 22 is magnified as indicated by magnification arrow 29. The magnified portion shows that the phosphor 24 can be carried as a film on the inner surface of the bulb 22. In other illuminator embodiments in which the bulb is a transparent or translucent polymer, the phosphor can be carried in various ways (e.g., as an external film, deposited within the polymer, and formed into sheets which are laminated on or within the polymer).

The redirector 25 is preferably hollow and fabricated from a material (e.g., aluminum or a metallized polymer) which is a good heat conductor. The redirector is positioned so that its outer surface is spaced inwardly from the bulb 22. The redirector is preferably supported by the base 23 which also serves as a portion of a heat path to remove generated heat. Although the redirector 25 can take on other shapes, it has a bulbous shape in the embodiment of FIGS. 1A-1C. To facilitate fabrication of this particular embodiment, the redirector comprises first and second redirector portions which are joined along a seam 30. The seam is visible through one of a plurality of windows 32 which are opened in the bulb 22 in FIGS. 1A-1C to expose elements and thereby facilitate their description.

When a redirector embodiment is formed of a metal (e.g., aluminum), each of the redirector portions may be easily formed by a conventional process (e.g., deep drawing or blow molding) prior to joining along the seam 30 with another conventional process (e.g., welding). When a redirector embodiment is formed of a polymer, each of the redirector portions may be formed by a conventional process (e.g., injection molding) prior to joining along the seam 30 with another conventional process (e.g., pressure and/or heating). In another fabrication embodiment, the redirector 25 may be formed as a single piece by using appropriate fabrication techniques (e.g., articulated tooling).

Preferably, the primary and secondary light sources (e.g., at least one LED 36 and at least one phosphor) are spaced apart by a void (i.e., an empty space) and the secondary light source is shaped about the primary light source to permit redirection and excitation processes in the illumination device 20 to be unimpeded. In addition, the redirector's outer surface is preferably configured to enhance its redirective quality. For example, embodiments of the redirector 33 may include a finish (e.g., a nickel plating or a high-gloss white coating) that enhances reflection of light. In other redirector embodiments, the surface of the redirector 33 may be configured in various shapes (e.g., facets 33 indicated in FIG. 1C) that enhance diffusion of the light that exits the illumination device 20. In yet other redirector embodiments, the surface of the redirector 33 may be configured (e.g., as a diffraction grating) to diffract the incident light to thereby modify or condition the light that exits the illumination device 20.

Although the bulb 22 and redirector 25 can be formed in embodiments that allow the redirector to be received within the bulb, the embodiments shown in FIGS. 1A-1C do not permit this because the diameter of the redirector exceeds the bulb's diameter where it joins the base 23. In the embodiments shown, therefore, the bulb 22 comprises first and second bulb portions which are joined along a seam 34. The redirector 25 can then be inserted into the lower bulb portion and fixed to the base 23 before the upper bulb portion is joined to form the finished bulb 22.

The redirector 24 forms a redirective support for carrying the LEDs 36 whose emitted light can energize the phosphor 24 that is carried by the bulb 22. The LEDs are preferably carried by a substrate 38 which also carries at least one conductor 39 (e.g., a metallic wire) that electrically connects to the electrodes of the LEDs 36. Although the substrate can be formed with various materials, it is formed of a transparent or translucent flexible polymer (e.g., polyethylene or polypropylene) in at least one embodiment. In this embodiment, it easily takes on the shape of the bulbous redirector which supports it. The substrate 38 carries the conductor 39 down into the base 23 where it joins to the base contacts 27 and 28 or joins to electronic elements which are, in turn, joined to the base contacts.

In the device embodiment shown in FIGS. 1A-1C, nine of the LEDs 36 are carried by the substrate 38 and the substrate is shaped to space the LEDs over the upper portion of the redirector 25. In operation of the illumination device 20, each of the LEDs 36 are energized via the conductor 39 so that they emit light rays such as the ray 40 shown in association with one of the LEDs. A portion of the emitted light 40 passes through the phosphor 24 and continues outward as light ray 41. Another portion 42 is redirected between the redirector and the phosphor 24 and of this, a portion 43 also passes outward from the bulb 22. Accordingly, light issues from the LEDs and the surface of the redirector 25 redirects and enhances the amount of this LED-emitted light which is directed outwardly from the bulb 22 and the amount which excites the phosphor 24.

In response to excitation by both of the light rays 40 and 42, the phosphor 24 emits excitation light of which a portion 44 travels outward and a portion 45 travels inward to also be redirected from the redirector 25 so that at least some of the portion 45 also continues outward from the bulb 22. Accordingly, light is emitted from the excited phosphorus and the surface of the redirector 25 redirects and enhances the amount of this phosphorus-emitted light which is directed outwardly from the bulb 22.

These emission and excitation processes generate a substantial quantity of light and the redirection processes enhance the amount of this light that is directed outward from the illumination device 20. The light issuing outward from the device comprises a portion which was emitted from the LEDs at an LED wavelength and a portion which was emitted from the excited phosphorus at a phosphorus wavelength. The redirection and excitation processes insure that these portions are mixed and diffused. In a device embodiment, the phosphor 24 is arranged in a pattern (e.g., a checkered or spotted pattern). In another device embodiment, the phosphor is arranged to not have a pattern (e.g., in a continuous film) so that the device's light appears constant (i.e., with an absence of bright spots).

As noted above, the substrate 38 is shaped to space the LEDs 36 over the upper portion of the redirector 25. In the embodiment shown in FIGS. 1A-1C, the LEDs are thereby arranged in a somewhat irregular array of LEDs. In other device embodiments, it may enhance the illumination from a device to arrange the LEDs in a more regular array of LEDs.

In a device embodiment, the LEDs 36 may be blue LEDs which emit light with an emission peak below 480 nm (i.e., the emitted light has a spectrum with a peak below the wavelength of 480 nm). The phosphorus 24 is configured to be excited by this emission peak and emit light with an emission peak that differs from that of the LED light. Exemplary emission peaks of exemplary phosphors are above 500 nm and include the emission peaks of 540, 560, and 585 nm which are associated respectively with green, yellow, and orange light.

In one embodiment, each LED may emit blue light with an emission peak of 455 nm and the phosphorus may be excited to emit yellow light with an emission peak of 550 nm. As shown in FIG. 1A, emission, excitation and redirection processes cause a mix of the blue and yellow light to issue outward from the illumination device 20. The device structure enhances the mixing of these lights so that the resultant light has the appearance of diffused white light. In another embodiment, the phosphorus may be a mixture which is excited to emit green, yellow and red light which mixes with the blue light to again produce white light.

The illumination device 20 is thus configured to facilitate a selection of LED-emitted light and phosphorus-emitted light which may be selected to vary the emitted light's color rendering index (CRI). CRI is a measure of the ability of a light source to accurately reproduce the color of objects lit by the source's emitted light. The best possible rendition of colors is given by a CRI of 100 while the very poorest is given by a CRI of zero.

Another measure of the device's emitted light is given by its color temperature wherein light with a low color temperature on the order of 2800 degrees Kelvin (K) has a red-yellow tone, light with a color temperature on the order of 5000-6000K appears substantially white, and light with a high color temperature above 6000K has a blue tone. The illumination device 20 is thus configured to permit a selection of LED-emitted light and phosphorus-emitted light which may be mixed to realize a desired color temperature. In addition, the structure of the illumination device 20 mixes the LED-emitted light and phosphorus-emitted light so that it is diffused and appears as a uniform color. Without this structure, each LED would appear as a bright spot within a background of lower intensity.

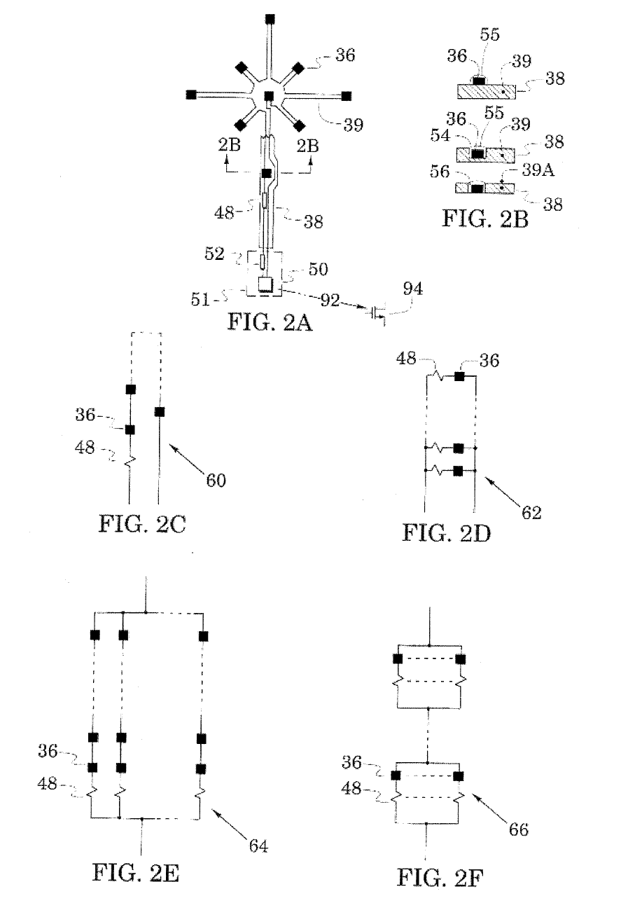

Attention is now directed to FIG. 2A which illustrates the substrate 38 and the conductor 39 before the substrate is draped over the redirector 25 in FIGS. 1A-1C (for illustrative clarity, only a portion of the substrate is shown). The conductor 39 may be carried on or within the substrate which is shown as a transparent substrate in this embodiment. If a resistor 48 is associated with the LEDs 36, it may also be carried on or within the substrate.

In some illumination structure embodiments, a semiconductor AC-DC voltage converter 50 may be fabricated on a miniature circuit such as an integrated-circuit chip 51 and connected to provide a desired DC voltage to the string of LEDs. In one embodiment, the LED current can be controlled with a semiconductor current mirror 52 which can be incorporated in the integrated-circuit chip 51. Various combinations of resistors, converters and current mirrors may be used to controllably set the voltage across each LED (e.g., in a range of 1.8 to 3.6 volts depending on the LED color) and the current through each LED (e.g., in a range of 15-20 milliamps depending again on the LED color).

FIG. 2B shows three enlarged views along the plane 2B-2B of FIG. 2A that illustrate different arrangement embodiments. In one of these embodiments, an LED 36 is carried on the substrate 38 and is covered with a substantially transparent potting compound 55 (e.g., epoxy) with the conductor 39 routed within the substrate. In another of these embodiments, an LED 36 is received in a pocket 54 of the substrate 38 and is covered with the potting compound 55. The conductor 39 is routed within the substrate. In yet another of these embodiments, an LED 36 is received in an aperture 56 of the substrate 38 so that it abuts the redirector (this is an example of surface mount technology (i.e., SMT). This view also shows an alternate position 39A of the conductor 39 in which it is carried over the substrate 38 (and preferably secured with a suitable compound (e.g., a cement)). Various other arrangement embodiments can be used including combinations of the illustrated ones.

In one embodiment, each LED 36 in FIG. 2B can be a singulated (i.e., cut from a semiconductor wafer) and unpackaged die (i.e., one semiconductor diode). In other embodiments, each LED 36 may comprise a diode that is carried in one of a variety of different package designs (e.g., Rohm Company, Ltd. is headquartered in Japan and provides LEDs in various packages (e.g., EMT, UMT and SMT packages) and also provides packaged LEDs under part numbers that begin with the letters SML). In yet other embodiments, each LED 36 may comprise a die and an associated phosphor that is spaced from the die (e.g., mixed in the compound 55).

In the structure of FIG. 2A, the conductor 39 is actually a series of conductors that facilitate current flow between anode and cathode of each LED. In LED embodiments in which the anode and cathode are on top and bottom of the LED, the conductors are suitably arranged to contact them. In another illumination embodiment, each LED may be structured (e.g., with a portion of one electrode removed to expose the second electrode below) so that the conductors can reach them from the same LED side. In a substrate embodiment, the conductors can be metallic wires carried on or within the substrate. In another substrate embodiment, the conductors can be realized with metallic plating carried on or within the substrate.

FIGS. 2C-2F illustrate different arrangements of LEDs 36 which may be carried along with resistors 48 in different configurations of the substrate 38 of FIG. 2A. The arrangements 60 and 62 are series and parallel arrangements while the arrangements 64 and 66 are parallel-serial and serial-parallel arrangements.

As shown in FIG. 1A, the illumination device 20 can emit light of selected color (light rays 41 and 43) from an LED 36 and also emit other color rays (light rays 44 and 45) from at least one excited phosphor 24. Various phosphors can be used to adjust the color temperature of the phosphor-emitted light and thereby adjust the color temperature of the mixed light that is produced by the device.

Studies have shown that the color temperature of light can have significant effects on humans. These effects may be related to changes in the hormone melatonin which is believed to be secreted by the brain and believed to play a role in regulating the body's internal clock. It has been found, for example, that blue light can lower blood pressure and have a calming effect while yellow light has the opposite effects.

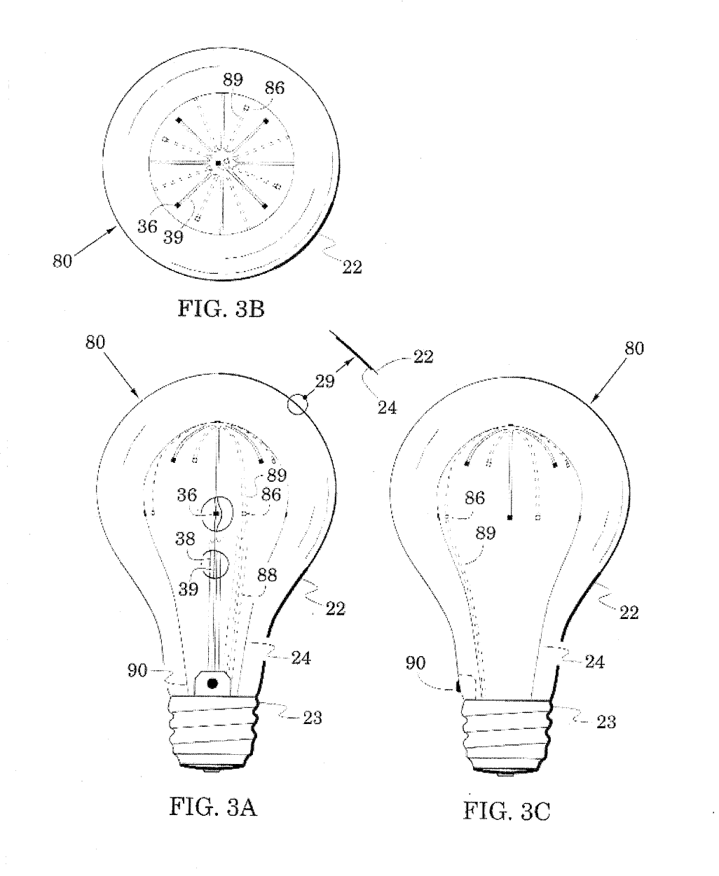

Although the phosphors of the illumination device 20 can be selected to adjust the color temperature of the device's light, the color temperature is fixed once this selection has been made and once the emitting wavelength of the LEDs 36 has also been selected. In contrast, the illumination device 80 of FIGS. 3A-3C is configured to facilitate further adjustment of the color temperature of the device's light.

The illumination device 80 includes elements of the device 20 of FIGS. 1A-1C with like elements indicated by like reference numbers. In particular, the device 80 includes the LEDs 36, substrate 38 and conductor 39 of the device 20. These elements are duplicated to form a second set which is shown as LEDs 86, substrate 88 and conductor 89 (for clarity of illustration, these latter elements are shown in broken lines, the LEDs are not darkened, and only lower portions of the substrates 38 and 88 are shown).

To make room for them, the LEDs 86, substrate 88 and conductor 89 are rotated (e.g., by 22.5 degrees) from the LEDs 36, substrate 38 and conductor 39. It is noted that the substrates 38 and 88 can also be combined into a single substrate. In addition, the conductors 38 and 88 are coupled to a switch 90 (e.g., a variable switch or a 3-way switch) adjacent the base 23.

The device 80 thus provides at least one phosphor 24 that is carried on the bulb 22 and also provides a first diode group comprising the LEDs 36 and a second diode group comprising the LEDs 86. In an exemplary device embodiment, the phosphor (or phosphors) 24 is selected to have an emission peak above 500 nm, the LEDs of the first diode group are configured to have first emission peaks located at a first spectral region below 480 nm, and the LEDs of the second diode group are configured to have second emission peaks located at a second spectral region below 480 nm that differs from the first region. With the switch 90, a device user can selectively energize either of the first and second diode groups.

For example, the phosphor can be a mix of green, yellow and red phosphors, the LEDs of the first group can have a first emission peak at 380 nm, and the LEDs of the second group can have a second emission peak at 470 nm. When the phosphors are excited by the LEDs of the first group, their emission peaks will shift relative to their locations when they are excited by the LEDs of the second group. Thus the emission peaks of both the LED-emitted light and the phosphor-emitted light can be selectively altered (e.g., via the integrated-circuit chip 51 of FIG. 2A) to thereby selectively alter the color temperature of the light issuing from the illumination device 80.

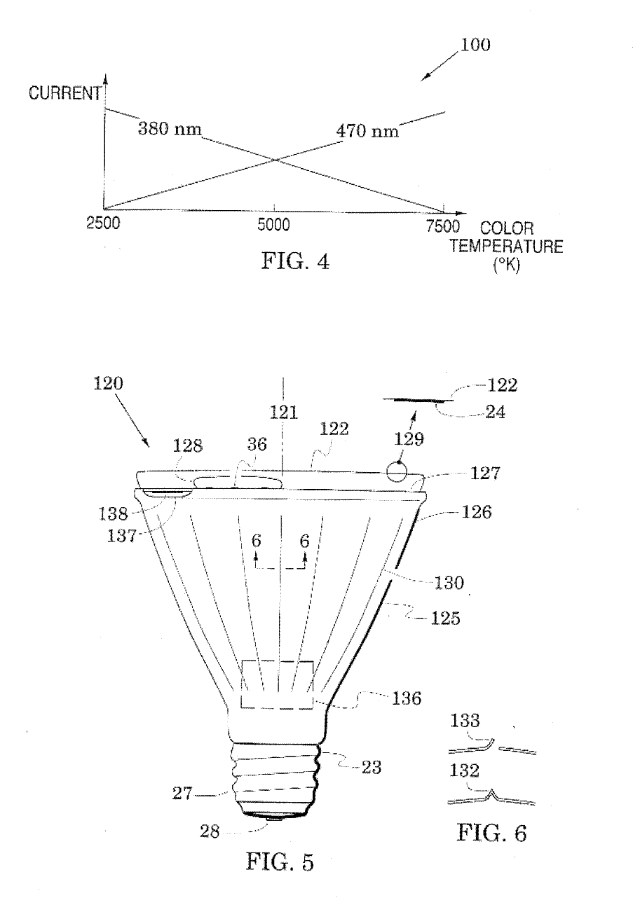

In other illumination device embodiments, the first and second groups of LEDs can both be commanded on with the currents of each of these groups selectively altered (e.g., via the integrated-circuit chip 51 of FIG. 2A) to provide further adjustment of the color temperature of the light provided by the illumination device. This adjustment method is illustrated in the graph 100 of FIG. 4 wherein first and second plots show that current in the 380 nm LEDs is decreased as current in the 470 nm LEDs is increased.

At the left side of the graph 100, the phosphors are being excited by light which contains a greater quantity of light from the 380 nm LEDs than from the 470 nm LEDs. In response, the wavelengths of the phosphor-emitted light tend to increase which lowers the color temperature of the light from the illumination device (e.g., to 2500K). At the right side of the graph 100, the phosphors are being excited by light which contains more light from the 470 nm LEDs than from the 380 nm LEDs. In response, the wavelengths of the phosphor-emitted light tend to decrease which raises the color temperature of the light from the illumination device (e.g., to 7500K). The light issuing from the illumination device can thereby be continuously adjusted from a red-yellow tone at one extreme to a blue tone at the other extreme.

The currents in the first and second groups of LEDs can be controlled with electronic switches (e.g., metal-oxide-semiconductor (MOS) transistors) that replace (or supplement) the mechanical switch 90 shown in FIGS. 3A and 3B. This is indicated in FIG. 2A where a substitution arrow 92 points from the switch 50 to a MOS transistor 94. The electronic switches can be activated from various selected locations or via various controllers (e.g., the integrated-circuit chip 51 of FIG. 2A).

In other device embodiments, a variety of different control circuits can be incorporated (e.g., the integrated-circuit chip 51 of FIG. 2A may be configured as a current controller 51) to control the current adjustment in the different LEDs. The current controller may be commanded, for example, by a user of the illumination device, by a computer-addressed bus, or by sensors that are monitoring external factors (e.g., time of day and/or room temperature). Color temperature of the illumination devices can thus be altered by selection of various device structures (e.g., mix of LEDs and mix of phosphors) and different LED operating parameters (e.g., variable LED currents). Because of this flexibility, these illumination devices can be referred to as “smart bulbs”. In a different embodiment, the current controller may be positioned external to the illumination device.

FIG. 5 illustrates another illumination device embodiment 120 which is configured to direct the majority of its illumination in a forward direction. That is, emitted light substantially forms a cone that is directed away from the device's base 23 and centered about a device centerline 121. The illumination device 120 is thus an efficient replacement for conventional illumination devices such as indoor ceiling-mounted floodlights and outdoor halogen floodlights that use an Edison screw base with threaded outer surface 27 and inner contact 28.

In contrast to the arrangement of the illumination device 20 of FIGS. 1A-1C in which a redirector 25 is received within a bulb 22, the illumination device 120 has a redirector 125 that rises from the base 23 and supports a bulb 122. The redirector has a lower flared portion 126 and an upper relatively flat upper portion 127 that receives the bulb. A cutout 128 of the bulb 122 shows that one or more strings of LEDs 36 may be carried by the upper portion and they may be accompanied by conductors and a substrate in a manner similar to the conductors 39 and substrate 38 of FIGS. 1A-1C. An area of the bulb 122 is magnified as indicated by magnification arrow 129 to show that a phosphor 24 may be carried as a film on the bulb's inner surface.

The lower portion of the redirector effectively acts as a heat path to direct heat away from the LEDs 36 by conducting a portion to the base 23 and radiating another portion outward from the redirector. This heat radiation is enhanced by configuring the lower portion to have a greater radiating area. For example, the lower portion can be configured with heat-radiating protuberances 130. FIG. 6 is a view along the plane 6-6 in FIG. 5 and illustrates that one protuberance embodiment may be elongate ribs such as a ridge 132 and a fin 133.

Electronic circuits 136 may be carried in the lower portion of the redirector 125. For example, a semiconductor AC-DC voltage converter may be fabricated as an integrated-circuit chip and connected to provide a desired DC voltage to the string of LEDs. Another cutout 137 shows that insulation 138 (e.g., a heat insulating silicon layer) may be carried over the inner surface of the redirector 125 to direct heat away from the circuits 136 and direct it, instead, downward to the base 23 or outward through the protuberances (e.g., 132 and 133).

It is important to note that the interior of disclosed illumination device embodiments need not be sealed from the exterior and there need not be a pressure differential between interior and exterior as in conventional illumination devices. This simplifies illumination device structure and reduces the cost of illumination device embodiments. It is further noted that other illumination device embodiments may eliminate the phosphor (24 in FIG. 5) from the inner surface of the bulb (122 in FIG. 5). In some illumination device embodiments, for example, the LEDs 36 may be colored LEDs (e.g., red, green or blue LEDs) and a surface of the bulb configured to condition the emitted light. For example, the surface may be configured in various shapes (e.g., facets or a diffraction grating) to diffuse and/or modify the light that exits the illumination device. Still other illumination device embodiments may be formed by the addition of one or more phosphors to the bulb.

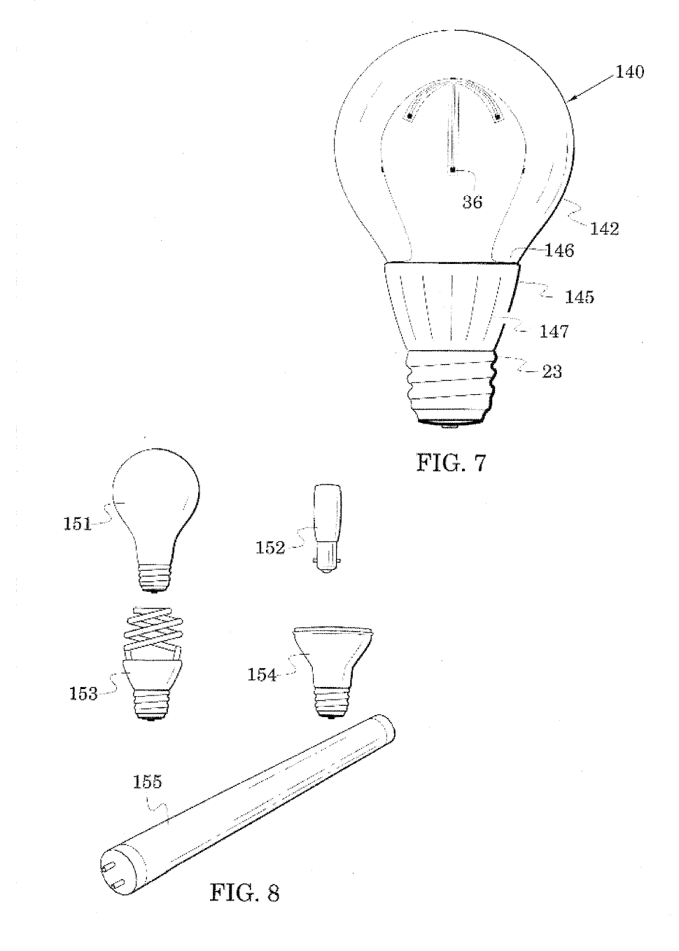

FIG. 7 illustrates another illumination device embodiment 140 that includes elements of the device 20 of. FIGS. 1A-1C but which also incorporates modifications of the heat radiation structures of the device 120 of FIG. 5. In the embodiment 20, it is realized that the LEDs 36 are generally positioned well away from the lower portion of the redirector 25 because it is intended that the generated light be directed upward and sideward rather than downward. The embodiment 140 is configured, therefore, to improve heat transfer in regions of the redirector that do not carry LEDs.

Accordingly, the redirector 25 has been modified to a redirector 145 that is partially within a reconfigured bulb 142 and partially outside of the bulb. A lower portion of the redirector extends upward from a base 23 and terminates in a step 146 that carries the bulb 142. Above this step, an upper portion of the redirector is essentially the same as the redirector 25 of FIGS. 1A-1C. The lower portion of the redirection is preferably configured with heat-radiating protuberances 147 that are similar to the ridges or fins 132 and 133 of FIG. 6.

The illustrated illumination device embodiments (and other embodiments which can be readily envisioned to achieve substantially equivalent results) offer substantial advantages over conventional illumination devices. For example, the average life span of LEDs is an order of magnitude greater than the life span of fluorescent devices and another order of magnitude greater than the life span of incandescent devices. The obtainable CRI of LEDs compares favorably with those of fluorescent and incandescent devices while the luminous efficacy (the fraction of electromagnetic radiation which is useful for lighting) of LEDs is significantly greater.

LEDs are more durable than fluorescent and incandescent devices and when the bulb 22 of FIGS. 1A-1C is realized as a polymer, its durability is also substantially greater. In contrast to fluorescent and incandescent devices, LED-generated light can be dimmed with little change in the color temperature. In addition, the illustrated and described illumination devices contain no mercury so that they are environmentally friendly. Although fluorescent and incandescent devices may be initially less expensive, the long life of the illustrated illumination devices and their lower power consumption more than offsets this initial difference.

The illumination devices illustrated in FIGS. 1-7 thus provide a number of advantages when they are substituted for conventional devices such as the Edison screw incandescent lamp 151, the bayonet mount incandescent lamp 152 (having an elongate bulb), the compact fluorescent lamp 153 (having a twisted bulb), the Edison screw flood lamp 154, and the fluorescent lamp 155 (having a tubular bulb with a straight bipin base at each end) and that are illustrated in FIG. 8. It is noted that bulbs of these illumination devices take on a variety of forms and are not restricted to a bulbous shape.

The embodiments of the invention described herein are exemplary and numerous modifications, variations and rearrangements can be readily envisioned to achieve substantially equivalent results, all of which are intended to be embraced within the spirit and scope of the appended claims

I claim:

1. An illumination device, comprising:
a primary light source;
a secondary light source arranged to provide secondary emitted light in excited response to primary emitted light from said primary light source; and
a redirector positioned to redirect at least a portion of said primary emitted light to excite further generation of said secondary emitted light.

2. The device of claim 1, wherein said primary light source comprises a plurality of primary light sources.

3. The device of claim 2, wherein said primary light source comprises an array of light-emitting diodes.

4. The device of claim 1, wherein said primary and secondary light sources are spaced apart by a void.

5. The device of claim 1, wherein said primary light source is positioned between said secondary light source and said redirector.

6. The device of claim 1, wherein said primary light source is carried by said reflector.

7. The device of claim 1, wherein said secondary light source is shaped about said primary light source.

8. The device of claim 1, wherein said redirector has a surface configured to redirect and diffuse at least a portion of said primary and secondary emitted lights.

9. An illumination device, comprising:
a secondary light source;
a redirector; and
a primary light source positioned to emit primary emitted light between said redirector and said secondary light source to excite generation of secondary emitted light from said secondary light source.

10. The device of claim 9, wherein said redirector has a surface configured to reflect at least a portion of said primary emitted light.

11. The device of claim 9, wherein said redirector has a surface configured to diffuse at least a portion of said primary and secondary emitted lights.

12. The device of claim 9, wherein said primary and secondary emitted lights have emission peaks located in different spectral regions.

13. The device of claim 9, wherein said primary light source comprises first and second primary light sources arranged to be selectively energized and configured to generate first and second primary emitted lights having first and second emission peaks in different spectral regions.

14. The device of claim 9, wherein said primary light source comprises first and second primary light sources arranged to carry selected currents and configured to generate first and second primary emitted lights having first and second emission peaks in different spectral regions.

15. The device of claim 9, further including a base that carries said redirector and is configured as a selected one of an Edison screw, a bayonet, and a straight bipin.

16. The device of claim 9, further including a substrate that positions said primary light source over said redirector.

17. An illumination device, comprising:
a bulb;
at least one phosphor carried by said bulb;
a redirector within said bulb; and
at least one light-emitting diode positioned between said bulb and said redirector to provide diode-emitted light that excites phosphor-emitted light from said phosphor.

18. The device of claim 17, wherein said redirector is shaped to redirect at least a portion of said diode-emitted light to further excite said phosphor.

19. The device of claim 17, wherein said redirector is configured to enhance diffusion of at least portions of said diode-emitted light and said phosphor-emitted light.

20. The device of claim 17, wherein said diode-emitted light has an emission peak below 480 nanometers and said phosphor-emitted light has an emission peak above 500 nanometers.

21. The device of claim 17, wherein said diode comprises:
a first group of diodes that have first emission peaks located in a first spectral region; and
a second group of diodes that have second emission peaks located in a second spectral region that differs from said first region.

22. The device of claim 17, further including a substrate that positions said diode over said redirector.

23. The device of claim 17, further including a base that carries said redirector and is configured as a selected one of an Edison screw, a bayonet, and a straight bipin.

24. An illumination device, comprising:
a bulb;
a base;
a redirector coupled to said base and configured to carry said bulb; and
at least one light-emitting diode carried by said redirector and positioned beneath said bulb.

25. The device of claim 24 wherein said redirector defines protuberances configured to facilitate heat radiation.

26. The device of claim 24 wherein said redirector includes a redirector portion that extends within said bulb to carry said diode.

27. The device of claim 24, wherein said light-emitting diode comprises a plurality of light-emitting diodes and further including phosphors that are each positioned adjacent a respective one of said diodes.

28. The device of claim 24, further including a phosphor carried on said bulb.

29. An illumination method, comprising the steps of:
directing an emitted light across a void;
in excited response to said emitted light, generating an excited light, and redirecting at least a portion of at least one of said emitted and excited lights to enhance at least one of said directing and generating steps.

30. The method of claim 29, further including the steps of:
providing said emitted light with an array of primary light sources; and
providing said excited light with a secondary light source that is shaped about said primary array.

31. The method of claim 30, wherein said primary light source is at least one light-emitting diode and said secondary light source is a phosphor.
